(19) United States
(12) Patent Application Publication
(10) Pub. No.: US 2009/0069067 A1
(43) Pub. Date: Mar. 12, 2009

(54) Slot Machine Which Awards A Payment Based On Scatter Symbols

(75) Inventor: Fumiya ABE, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE CORP., Tokyo (JP)

(21) Appl. No.: 12/204,501

(22) Filed: Sep. 4, 2008

(30) Foreign Application Priority Data
Sep. 6, 2007 (JP) JP2007-231399

(51) Int. Cl. A63F 9/24; A63F 13/00

(52) U.S. Cl. 463/20

(57) ABSTRACT

If there is a special symbol ([ORANGE] symbol) among symbols each rearranged in a symbol display frame 111 of a liquid crystal panel 5B, the special symbol is replaced with one of scatter symbols. Then a player can designate a scatter symbol rearranged in the symbol display frame 111 within the number of special symbols which are replaced with the scatter symbols by a touch through a touch panel 101. The designated scatter symbol is fixedly displayed. While in each symbol display area in which another scatter symbol is rearranged, each video reel scrolls and rotates, so as to again rearrange one symbol therein, respectively.

### CROSS-REFERENCE TO RELATED APPLICATIONS

This application is based upon and claims a priority from the prior Japanese Patent Application No. 2007-231399 filed on Sep. 6, 2007, the entire contents of which are incorporated herein by reference.

### BACKGROUND

1. Field

The present invention relates to a slot machine which awards a payment based on scatter symbols.

2. Description of Related Art

In a conventional slot machine which awards a payment based on scatter symbols, the payment is awarded according to the number of scatter symbols displaying on a display (Refer to US 2002/0039920A1 which has the foreign application priority data that are Aug. 22, 2000 (AU) and PQ9587). Further, there is a slot machine wherein, following guidance, a player touches specific symbols displayed on a display through a touch panel (Refer to US 2006/0046831A1).

However, as a player cannot intervene in rearranging of symbols in a slot game, the player can only expect a random payment even if a payment based on scatter symbols is awarded.

### SUMMARY

Accordingly, the present invention has been made in light of the above, and it is an object of the invention to provide an unprecedented novel slot machine characterized by increasing entertainability in rearranging of scatter symbols.

To achieve the object of the disclosure, there is provided a slot machine, comprising: a display which displays a plurality of symbols, the plurality of symbols randomly displayed among a plurality of scatter symbols, number of which is a basis of awarding a prize to a player, and a special symbol; a touch panel through which the player designates any of the plurality of symbols displayed on the display; and a processor controlling the display and the touch panel, programmed to execute processes of: (a) rearranging the plurality of symbols displayed on the display; (b) if the special symbol is displayed on the display as a result of the rearranging, allowing the player to designate any of the plurality of scatter symbols displayed on the display through the touch panel; and (c) if one of the plurality of scatter symbols is designated by the player, fixedly displaying the scatter symbol designated, and rearranging the plurality of symbols except the scatter symbol designated.

Furthermore, according to another aspect, there is provided a slot machine, comprising: a display which displays a plurality of symbols, the plurality of symbols randomly displayed among a plurality of scatter symbols, number of which is a basis of awarding a prize to a player, and a special symbol; a touch panel through which the player designates any of the plurality of symbols displayed on the display; and a processor controlling the display and the touch panel, programmed to execute processes of: (a) rearranging the plurality of symbols displayed on the display; (b-1) if the special symbol is displayed on the display as a result of the rearranging, allowing the player to designate any of the plurality of scatter symbols displayed on the display through the touch panel; (b-2) if the special symbol is displayed on the display, replacing the special symbol which is displayed with one of the plurality of scatter symbols; (b-3) limiting the number of scatter symbols which the player is allowed to designate through the touch panel within the number of special symbols displayed on the display; and (c) if one of the plurality of scatter symbols is designated by the player, fixedly displaying the scatter symbol designated, and rearranging the plurality of symbols except the scatter symbol designated.

### BRIEF DESCRIPTION OF THE DRAWINGS

FIG. 1 is a view showing characteristics of a slot machine according to one embodiment of the present invention;

FIG. 2 is a perspective view of the slot machine;

FIG. 3 is a schematic view showing symbol columns drawn on reel band of each reel;

FIG. 4 is a block diagram schematically showing an internal construction of entire slot machine;

FIG. 5 is a block diagram schematically showing an internal construction of a sub control board;

FIG. 6 is a payout table showing winning combinations and payout amounts thereof when a slot game is conducted by using the reels;

FIG. 7 is an explanatory view showing an image example displayed on a liquid crystal panel;

FIG. 8 is an explanatory view showing the other image example displayed on the liquid crystal panel;

FIG. 9 is a flowchart of a main control program;

FIG. 10 is a flowchart of a main game process program;

FIG. 11 is a flow chart of a symbol display control process program;

FIG. 12 is a flowchart of a symbol designation process program.

### DETAILED DESCRIPTION

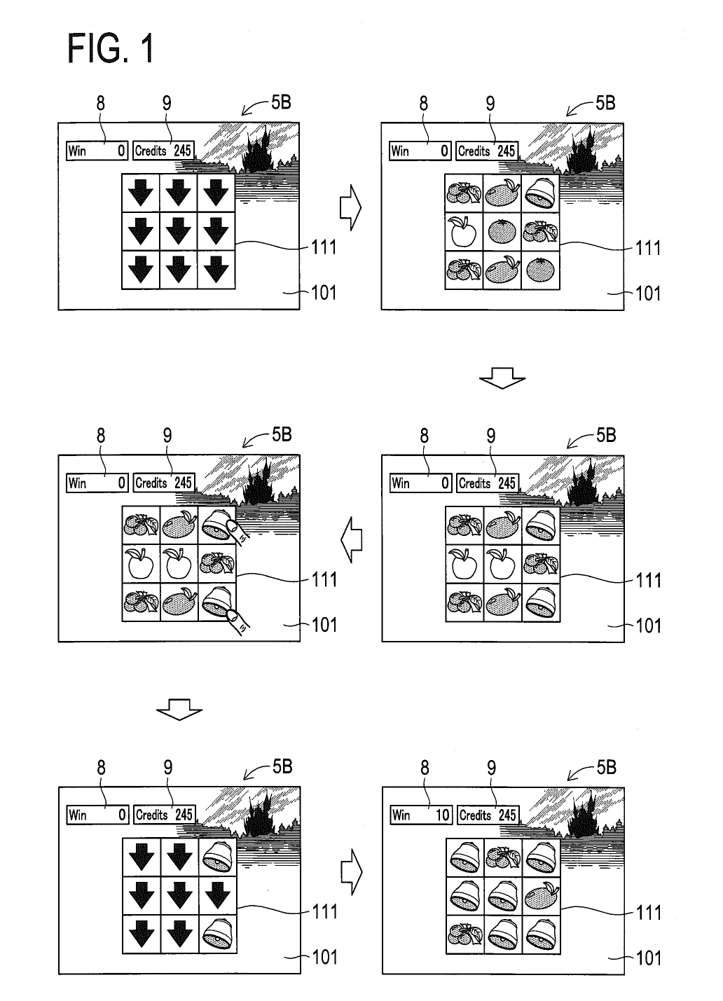

In the following, a description is made on embodiments of the present invention with reference to the drawings. FIG. 1 is a view showing characteristics of a slot machine that is one embodiment of the present invention. Additionally, when a liquid crystal panel 5B shown in FIG. 1 is specified, it is described by the No. of the stage from the uppermost stage of the figure.

Games to be played in the slot machine according to this embodiment consist of slot games that use scatter symbols and special symbols.

As shown in FIG. 1, in this slot game, a symbol display frame 111 within which nine symbols are positioned like a matrix of three rows times three columns is displayed on a well-known liquid crystal panel 5B. In this respect, within the symbol display frame 111, nine symbol display areas, where one of many symbols drawn on a reel band of one video reel is arranged, are positioned like a matrix of three rows times three columns. In other words, one symbol display area is assigned to each of the nine video reels. Then, each one of symbols drawn on the reel band of each video reel is arranged in each symbol display area. Further, a payout amount display portion 8 and a credit amount display portion 9 are provided on the liquid crystal panel 5B. Additionally, a touch panel 101 is provided on the front side of the liquid crystal panel 5B.

On the other hand, various types of winning combinations are preset based on the number of same scatter symbols. Then, in each symbol display area of the symbol display frame 111 as in respective liquid crystal panels 5B shown in the picture on both sides in the first stage in FIG. 1, symbols are rearranged one by one as a result of each video reel's scrolling, rotating and stopping. Then, if the nine symbols rearranged in the symbol display frame 111 comprise any of the winning combinations, a payout amount according to that winning combination is displayed on the payout amount display portion 8 (refer to the picture on the right in the third stage in FIG. 1, for example). This constitutes a unit game. Additionally, a payout amount displayed on the payout amount display portion 8 is added to and displayed on the credit amount display portion 9 when the unit game is terminated.

Further, assume that in each unit game, as shown in the liquid crystal panel 5B shown in the picture on the right side in the first stage in FIG. 1, any of the nine symbols rearranged in the symbol display frame 111 have an [ORANGE] symbol, which is a special symbol, at the point of time when the symbols are rearranged in the symbol display frame 111 of the liquid crystal panel 5B. In this case, the special symbols ([ORANGE] symbols) are automatically replaced with any of the scatter symbols. For example, in the liquid crystal panel 5B shown in the picture on the right side in the first stage in FIG. 1, two special symbols ([ORANGE] symbols) are automatically replaced with [APPLE] and [BELL] of the scatter symbols, thus the liquid crystal panel 5B being as shown in the picture on the right side in the second stage in FIG. 1.

Thereafter, as in the liquid crystal panel 5B shown in the picture on the left side in the second stage in FIG. 1, a player can designate any of the scatter symbols rearranged in the symbol display frame 111 by touching it via the touch panel 101, with limits of the number of the special symbols ([ORANGE] symbols) that have been replaced with any of the scatter symbols.

At this time, the player can also designate the scatter symbols that replaced the special symbols ([ORANGE] symbols). Alternatively, the player can designate no scatter symbol.

Subsequently, as in the liquid crystal panel 5B shown in the picture on both sides in the third stage in FIG. 1, the scatter symbols designated by the player are fixedly displayed in the symbol display frame 111 in a next unit game. In the respective symbol display areas in which other scatter symbols are rearranged, the symbols are rearranged one by one as a result of each video reel's scrolling, rotating and stopping. Then, if the special symbol ([ORANGE] symbol) is rearranged in the symbol display frame 111 of the liquid crystal panel 5B, automatic replacement or designation of symbols by the player as described above is carried out again.

As such, each unit game of the slot game is repeated.

Hereinafter, the embodiment embodying the present invention will be described in detail with reference to the drawings.

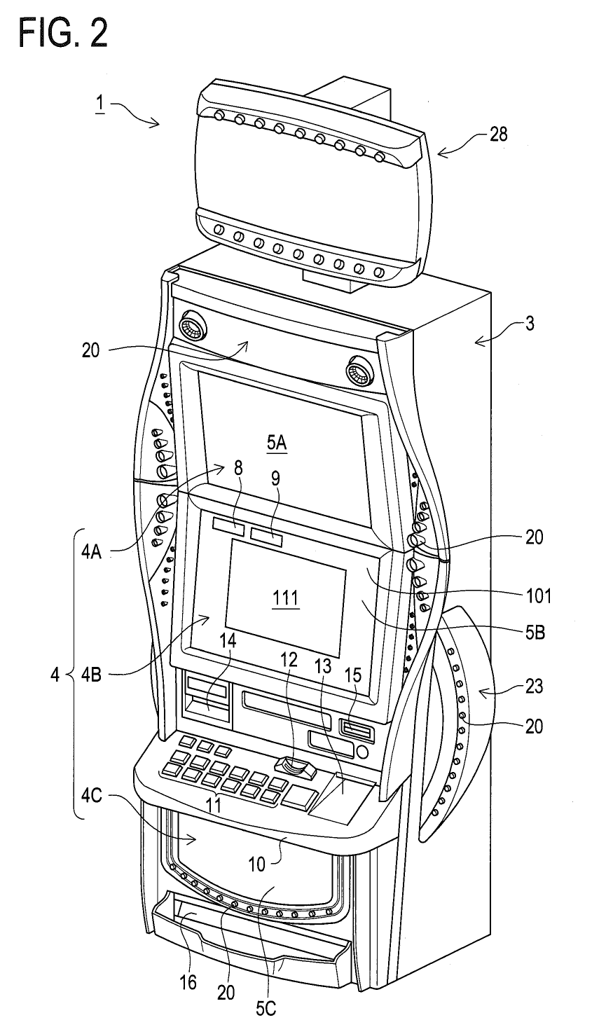

First, an outline construction of the slot machine 1 according to the embodiment is described with reference to FIG. 2. FIG. 2 is perspective view of the slot machine 1 according to the embodiment.

As shown in FIG. 2, the slot machine 1 is an upright type slot machine arranged in the game arcade such as casino, in order to execute predetermined game modes, such slot machine includes a cabinet 3 in which electronic and mechanical components are installed. For example, as a display portion 4 to display information concerning the game, there are provided an upper display portion 4A, a middle variable display portion 4B and a lower display portion 4C. Each display portion 4A to 4C is mounted at the front of the oblong cabinet 3. The upper display portion 4A includes a liquid crystal panel 5A which is arranged above the middle variable display portion 4B. On the liquid crystal panel 5A, for example, the effect image, the introduction of the game content, and the rule explanation of the game are displayed. The lower display portion 4C is arranged below the middle variable display portion 4B, and includes a plastic panel 5C on which the images are printed, and the plastic panel 5C is lightened by the backlights.

The middle variable display portion 4B includes the liquid crystal panel 5B which is fixed at the front door of the cabinet 3. In this liquid crystal panel 5B, nine symbols of the video reels are displayed in a rotating manner and in a stopped manner, respectively. In the middle variable display portion 4B, the symbol display frame 111 in which the nine symbol display areas associated with each video reel are positioned like a matrix of three rows times three columns is displayed on the liquid crystal panel 5B. Further, the touch panel 101 is provided on the front surface of the liquid crystal panel 5B, and by operating the touch panel 101, the player can enter various instructions or designation of scatter symbols. On the upper position of the middle variable display portion 4B, the payout amount display portion 8 and the credit amount display portion 9 are arranged on the liquid crystal panel 5B. Also the upper portion of the middle variable display portion 4B, is related to the back side, thereby the player may play games in a cozy posture.

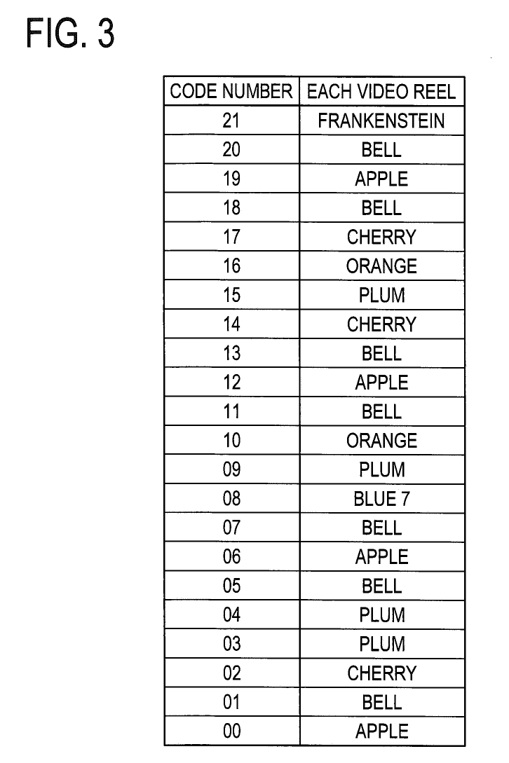

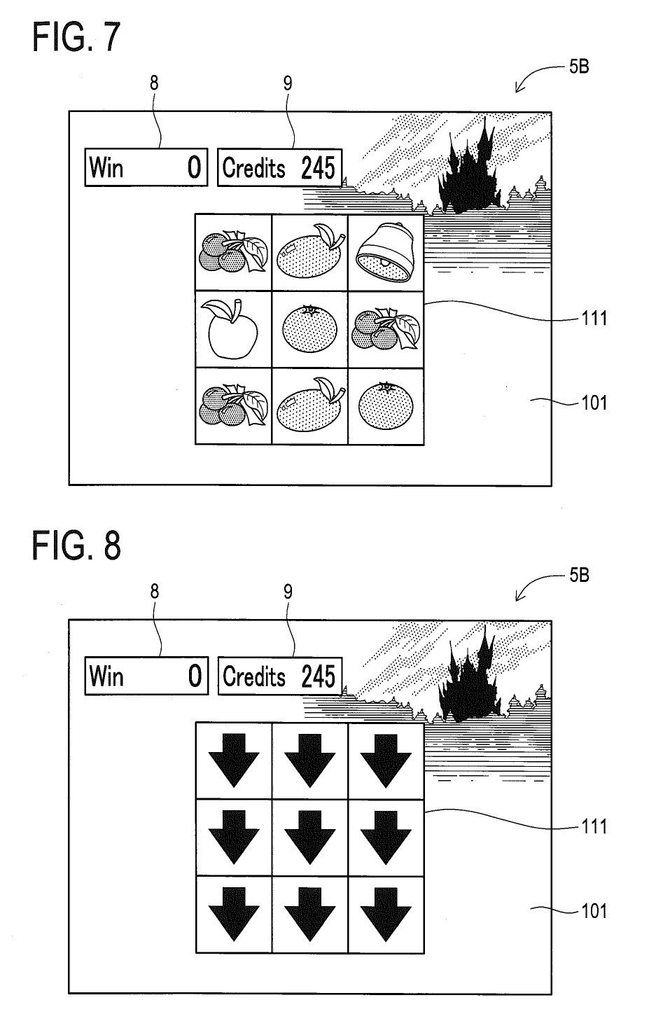

Now, images of a slot game to be displayed on the liquid crystal panel 5B are described. FIG. 7 and FIG. 8 are the figures showing the contents displayed on the liquid crystal panel 5B, by way of example. As shown in FIG. 7 and FIG. 8, on the liquid crystal panel 5B during a slot game, the symbol drawn on the reel band of each video reel is displayed in the nine symbol display areas positioned like a matrix of three rows times three columns in the symbol display frame 111, so that they can be viewed by a player. FIG. 7 shows a state in which the symbol drawn on the reel band of each video reel is arranged or rearranged in each symbol display area of the symbol display frame 111 on the liquid crystal panel 5B. FIG. 8 shows a state in which the symbol drawn on the reel band of each video reel is rotationally displayed in each symbol display area of the symbol display frame 111 on the liquid crystal panel 5B. On the reel band of each video reel, a symbol column constructed from twenty-two symbols is displayed respectively (refer to FIG. 3).

On the liquid crystal panel 5B, the payout amount display portion 8 and the credit amount display portion 9 are arranged. On the payout amount display portion 8, the payout amount awarded in a slot game to a player is displayed. On the credit amount display portion 9, the credit counts which is owned by the current player is displayed.

Therefore, on the liquid crystal panel 5B in a slot game, one symbol which is drawn on the reel band of each video reel is arranged in each symbol display area of the symbol display frame 111.

Returning to FIG. 2, between the middle variable display portion 4B and the lower display portion 4C, at the front of the cabinet 3, an operation table 10 which is projected forward is arranged. On the operation table 10, a variety of operation buttons 11 including a BET button, a collecting button, a spin button, a CASHOUT button, are arranged as the operation portion to execute the game. On the operation table 10, a coin insertion slot 12 and a bill insertion slot 13 are arranged. Also between the operation table 10 and the middle variable display portion 4B, a ticket printer 14 and a card reader 15 are arranged. At the lowest position of the cabinet 3, a coin tray 16 is also arranged.

In the slot machine 1 of the embodiment, the gaming medium may be coin, bill, or electronic value (credit). Here, the gaming medium may be others as well, such as medal, token, electronic money, or ticket.

On the cabinet 3 of the slot machine 1, light emitting portions 20 are arranged around the game area including the upper display portion 4A, the middle variable display portion 4B, the lower display portion 4C and the operation table 10.

The slot machine 1 also includes a topper effect device 28 which is installed on the cabinet 3. The topper effect device 28 is shaped in a rectangular board shaped, and is arranged almost parallel to the liquid crystal panel 5A of the upper display portion 4A. The cabinet 3 is further provided with speakers 23 on its both sides.

Next, the symbols displayed on the reel band of each video reel will be explained with reference to FIG. 3. These symbols are scrolled and rearranged in each symbol display area of the symbol display frame 111 on the liquid crystal panel 5B during a slot game. FIG. 3 is a schematic view schematically showing symbol columns drawn on the reel band of each video reel.

On the reel band of each video reel, twenty-two symbols are arranged respectively. Each symbol column of video reel is constructed from the symbols including [FRANKENSTEIN], [BLUE7], [BELL], [APPLE], [CHERRY], [STRAWBERRY], [PLUM] and [ORANGE]. And the symbols of the predetermined types are arranged in a predetermined sequence.

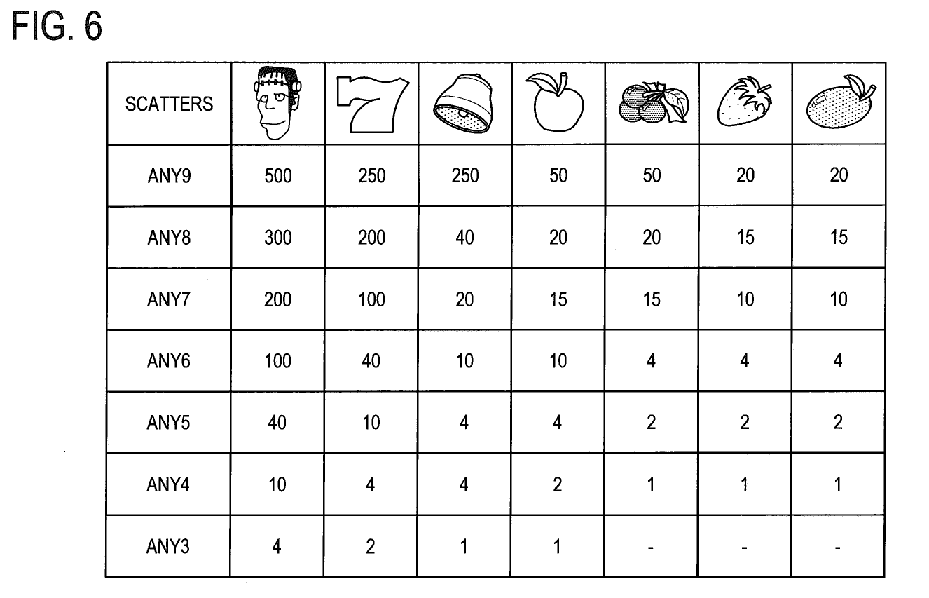

Here, [FRANKENSTEIN], [BLUE7], [BELL], [APPLE], [CHERRY], [STRAWBERRY] and [PLUM] are scatter symbols. When more than three or four symbols of [FRANKENSTEIN], [BLUE7], [BELL], [APPLE], [CHERRY], [STRAWBERRY] and [PLUM] are rearranged in the symbol display frame 111 of the liquid crystal panel 5B, a predetermined payout amount is awarded to a player (refer to FIG. 6). Also, regarding the symbol of [ORANGE], [ORANGE] is special symbol. Even when [ORANGE] is rearranged in the symbol display frame 111 of the liquid crystal panel 5B, a payout amount corresponding to the number of the symbols is not awarded to a player (refer to FIG. 6).

In particular, as described above, when the special symbol [ORANGE] is rearranged in the symbol display areas of the symbol display frame 111 on the liquid crystal panel 5B, it is automatically replaced with any of the scatter symbols [FRANKENSTEIN], [BLUE7], [BELL], [APPLE], [CHERRY], [STRAWBERRY], and [PLUM].

To each symbol consisting each symbol column of video reel shown in FIG. 3, a symbol number is allocated from top to down in sequence.

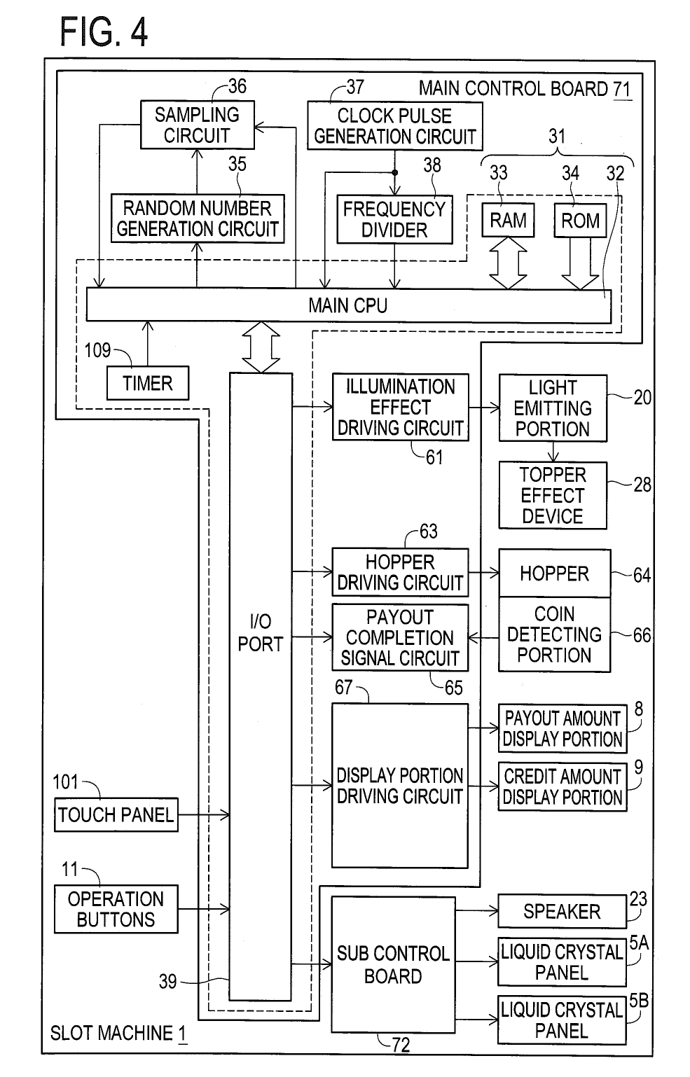

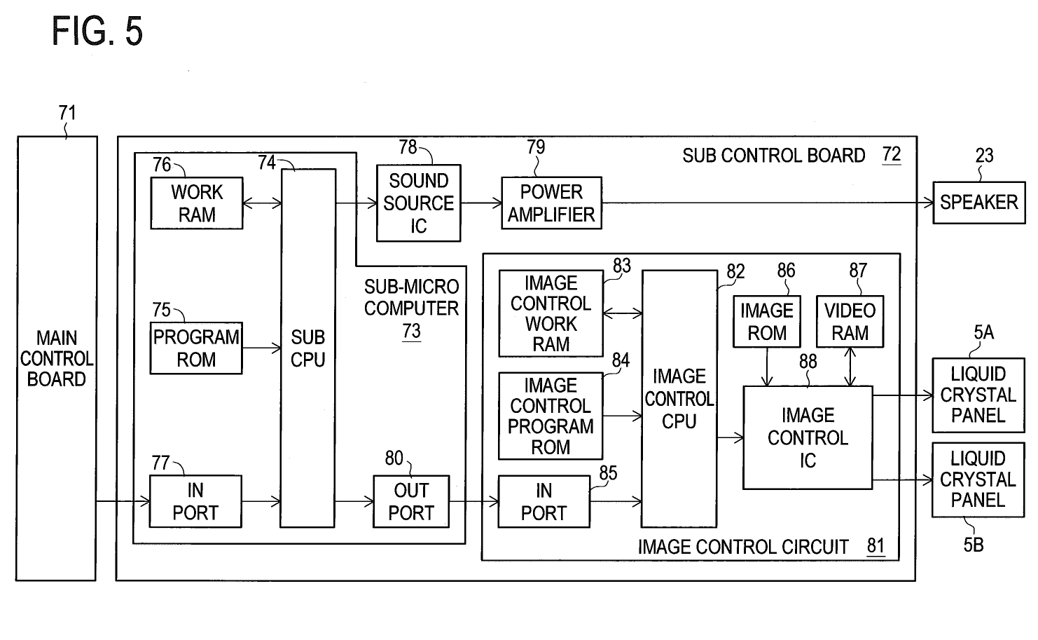

Next, the internal construction of the above slot machine 1 will be explained with reference to FIG. 4 and FIG. 5.

FIG. 4 is a block diagram schematically showing the internal construction of entire slot machine 1. As shown in FIG. 4, the slot machine 1 includes a plurality of construction elements such as the main control board 71, in which a microcomputer 31 is included. The main control board 71 is constructed from a microcomputer 31, a random number generation circuit 35, a sampling circuit 36, a clock pulse generation circuit 37, a frequency divider 38 and a timer 109. The main control board 71 also includes an illumination effect driving circuit 61, a hopper driving circuit 63, a payout completion signal circuit 65 and a display portion driving circuit 67.

The microcomputer 31 is constructed from a main CPU 32, a RAM 33 and a ROM 34. The main CPU 32 runs based on the programs stored in the ROM 34, and inputs/outputs signals with other elements through I/O port 39, so as to execute the control of the entire slot machine 1. Data and programs used when the main CPU 32 runs are stored in the RAM 33. For example, random numbers which are sampled by the after-mentioned sampling circuit 36 are stored temporarily after the start of the game, also the code number of each video reel and the symbol numbers are stored in the RAM 33. Further, in the RAM 33, a storage area of each variables N, M is set in advance. And the programs executed by the main CPU 32 and the permanent data are stored in the ROM 34.

Especially, the programs stored in the ROM 34 include the game programs and the game system programs (abbreviated as “the game programs and the like” hereinafter). And a lottery program mentioned below is also included in the game programs.

The lottery program is a program used to determine the code number of each video reel which corresponds to each symbol rearranged in each symbol display area of the symbol display frame 111 on the liquid crystal panel 5B. In the lottery program, it is included symbol weighting data corresponding to each of plural kinds of payout rates (for example, 80%, 84% and 88%). The symbol weighting data are the data indicating correlation between the code number of each video reel and one or plural random numbers belonging to a predetermined number range (0 to 255), every each of the nine video reels. In other words, each of the code number of one reel is associated with one or more random numbers corresponding to the payout rate. The random number is extracted by the lottery program, and the symbol specified finally by the random number is rearranged in each symbol display area of the symbol display frame 111 on the liquid crystal panel 5B.

Additionally, when the scatter symbol (each symbol of [FRANKENSTEIN], [BLUE7], [BELL], [APPLE], [CHERRY], [STRAWBERRY], and [PLUM]) automatically replaces the special symbol ([ORANGE] symbol), the lottery program for determining a code number (corresponding to the code number of video reel) associated with a scatter symbol to be replaced is similarly configured so that symbol weighting data corresponding to each of plural kinds of payout rates (for example, 80%, 84% and 88%) is included.

Random numbers over a predetermined range are generated by the random number generation circuit 35, which is operated based on the instructions from the main CPU 32. The random numbers are voluntarily extracted from the random numbers generated by the random number generation circuit 35 by the sampling circuit 36, based on the instructions from the main CPU 32, and the extracted random numbers are input to the main CPU 32. The base clock for running the main CPU 32 is generated by the clock pulse generation circuit 37, and the signals which are generated by dividing the base clock in a predetermined frequency are input to the main CPU 32 by the frequency divider 38. The timer 109 inputs into the main CPU 32 a signal notifying when to execute the process.

The touch panel 101 is connected to the main control board 71. The touch panel 101 is arranged in front of the liquid crystal panel 5B, and specifies the coordinate position of the portion touched by a player. The position on which the player touched and the direction of the movement of the touched portion are determined based on the specified coordinate position information. And the signals corresponding to the determination are input to the main CPU 32 through I/O port 39.

Also, the operation buttons 11 for instructing the execution of the game are connected to the main control board 71. The operation buttons 11 include the spin button, the collecting button and the BET button and the like. The signals corresponding to the pressing of these buttons are input to the main CPU 32 through I/O port 39.

The effect signals which are used to conduct illumination effect are output to the above-mentioned light emitting portion 20 and the topper effect device 28 by the illumination effect driving circuit 61. And the topper effect device 28 is serially connected to the illumination effect driving circuit 61 through light emitting portions 20.

A hopper 64 is driven by the hopper driving circuit 63 based on the control of main CPU 32. The hopper 64 executes the payout of coins, and coins are paid out from the coin tray 16. The data of the number of coins are input from the connected coin detecting portion 66 by the payout completion signal circuit 65. When the number of coins becomes a predetermined number, the signal indicating the completion of the coins is input to the main CPU 32. The number of the coins paid out from the hopper 64 is calculated by the coin detecting portion 66, and the data of the number calculated are input to the payout completion signal circuit 65. The display operation of the payout amount display portion 8 and credit amount display portion 9 is controlled by the display portion driving circuit 67.

Furthermore, a sub-control board 72 is connected to the main control board 71. As shown in FIG. 5, commands from the main control board 71 are input to the sub-control board 72. The display control on the liquid crystal panel 5A of the upper display portion 4A and the liquid crystal panel 5B of the variable display portion 4B, and the sound output control on speakers 23 is executed by the sub-control board 72. The sub-control board 72 is constructed on a circuit board different from the circuit board for the main control board 71, and includes a microcomputer 73 (abbreviated as “sub-microcomputer” hereinafter) as a main construction element, and a sound source IC 78, a power amplifier 79 and an image control circuit 81. The sound source IC 78 controls the sound output from the speaker 23, the power amplifier 79 is used as an amplification device, and the image control circuit 81 is used as the display control device of the liquid crystal panel 5A and 5B.

The sub-microcomputer 73 includes a sub CPU 74, a program ROM 75, a work RAM 76, an IN port 77 and an OUT port 80. The control operations are executed by sub CPU 74 based on the control order transmitted from the main control board 71, the program ROM 75 is used as a memory device. Although a clock pulse generation circuit, a frequency divider, a random number generation device and a sampling circuit are not included in the sub-control board 72, the sub-control board 72 is constructed so as to execute random number sampling according to the operation programs thereof. The control programs executed by the sub CPU 74 are stored in the program ROM 75. The work RAM 76 is constructed as a temporary storing device when the above control programs are executed by the sub CPU 74.

The image control circuit 81 includes an image control CPU 82, an image control work RAM 83, an image control program ROM 84, an IN port 85, an image ROM 86, a video RAM 87 and an image control IC 88. The images displayed on the liquid crystal panel 5A and 5B are determined by the image control CPU 82, based on the parameters set by the sub-microcomputer 73, according to the image control programs stored in the image control program ROM 84.

The image control programs regarding to the display of the liquid crystal panel 5A, 5B and a variety of the selection tables are stored in the image control program ROM 84. The image control work RAM 83 is constructed as a temporary storing device when the image control programs are executed by image control CPU 82. Images corresponding to the content determined by the image control CPU 82 are formed by the image control IC 88, and are output to the liquid crystal panel 5A, 5B.

In the image ROM 86, the dot data used to form images are stored. Thus, it stores the dot data on symbols drawn on the reel band of the each video reel. The video RAM 87 runs as a temporary storing means when the images are formed by the image control IC 88.

Further, based on control signals from the main CPU 32, the image control circuit 81 performs display control of rotational display/stop display of the video reels in the respective symbol display areas of the symbol display frame 111 on the liquid crystal panel 5B. Furthermore, based on control signals from the main CPU 32, the image control circuit 81 also performs display control of replacement of a special symbol with a scatter symbol in the respective symbol display areas of the symbol display frame 111 on the liquid crystal panel 5B.

Next, winning combinations and the payout amounts corresponding to the winning combinations will be explained with reference to FIG. 6, wherein the winning combinations are the symbol combinations when a slot game is executed by using each of the video reels in the slot machine 1 according to the embodiment. FIG. 6 is a payout table in which the winning combinations and the payout amounts corresponding to the winning combinations are shown when a slot game is executed by using each of the video reels.

Here, the payout amount shown in FIG. 6 indicates the payout amount when the bet number is “1”. Therefore, when the bet number is “1”, the payout amount shown in FIG. 6 is paid out, and when the bet number is more than “2”, the payout amount obtained by multiplying the payout amount shown in FIG. 6 with the bet number is paid out.

Therefore, when nine [FRANKENSTEIN] scatter symbols are rearranged in the symbol display frame 111 of the liquid crystal panel 5B, an amount by multiplying 500 credits by the bet number is paid out. Further, if the eight [FRANKENSTEIN] scatter symbols are rearranged in the symbol display frame 111 of the liquid crystal panel 5B, an amount by multiplying 300 credits by the bet number is paid out. In the following, similarly, according to the number of [FRANKENSTEIN] scatter symbols rearranged in the symbol display frame 111 of the liquid crystal panel 5B, payout amounts as shown in FIG. 6 are set.

Also for each scatter symbol of [BLUE7], [BELL], [APPLE], [CHERRY], [STRAWBERRY] and [PLUM], similarly in the following, the payout amounts as shown in FIG. 6 are set according to the number of same scatter symbols rearranged in the symbol display frame 111 of the liquid crystal panel 5B. However, if the number of same scatter symbols rearranged in the symbol display frame 111 of the liquid crystal panel 5B is not any of the numbers shown in FIG. 6, it means a loss, and no payout is made to a loss.

As mentioned above, in the slot machine 1 according to the embodiment, the slot game is executed.

In other words, in a slot game, the slot game is executed by rearranging the plurality of same symbols specified by 9 video reels in the symbol display frame 111 of the liquid crystal panel 5B. In the slot game, firstly, a part of symbol column (one symbol) drawn on the reel band of each video reels (shown in FIG. 3), is arranged in each symbol display area of the symbol display frame 111 on the liquid crystal panel 5B (refer to FIG. 7). Here, after a player sets the bet number by pressing the bet button among the operation buttons 11, if the player presses the spin button, each of the video reels rotates, the symbol column drawn on the reel band of each video reel shown in FIG. 3, is scrolled from up to down in the symbol display frame 111 of the liquid crystal panel 5B (refer to FIG. 8).

After a predetermined time, each video reel stops automatically, a part of the symbol column (one symbol) drawn on the reel band of each video reel (shown in FIG. 3), is rearranged in each symbol display area of the symbol display frame 111 on the liquid crystal panel 5B (refer to FIG. 7). On the other hand, each winning combination based on each the number of scatter symbol is determined beforehand (refer to FIG. 6). When the symbol combination constructed from the nine symbols rearranged in the symbol display frame 111 of the liquid crystal panel 5B, realizes a winning combination specified by the number of same symbol, the payout amount obtained by multiplying the bet number with the payout amount corresponding to the realized winning combination is awarded to a player.

However, if the special symbol ([ORANGE] symbol) is rearranged again in the symbol display frame 111 of the liquid crystal panel 5B, it is automatically replaced with any of the scatter symbols ([FRANKENSTEIN], [BLUE7], [BELL], [APPLE], [CHERRY], [STRAWBERRY], and [PLUM]).

Subsequently, by touching and inputting on the touch panel 101, the player can designate any of the scatter symbols rearranged in the symbol display frame 111 of the liquid crystal panel 5B, with limits of the number of the special symbols ([ORANGE] symbols) that were automatically replaced with any scatter symbol. Further, when the player presses the operation button 11 of the spin button after pressing the operation button 11 of the BET button and setting the bet number, the scatter symbol designated by the player is fixedly displayed in the symbol display frame 111 of the liquid crystal panel 5B, while in symbol display areas other than the symbol display areas in which the scatter symbols are fixedly displayed, each video reel rotates and a symbol sequence drawn on the reel band of each video reel as shown in FIG. 3 is scroll displayed from top to down.

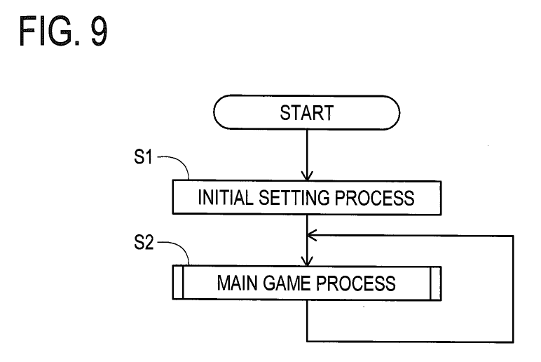

Next, the main control program executed in the slot machine 1 according to the embodiment will be explained with reference to figures. FIG. 9 is a flowchart of the main control program.

First, when a power switch is pressed, the microcomputer 31 is started to operate, an initialization is executed by the microcomputer 31 in step (abbreviated as “S”) 1. In an initialization process, the BIOS stored in the ROM 34 is executed by the main CPU 32. The compressed data included in the BIOS is expanded to the RAM 33, and when the BIOS expansion to the RAM 33 is executed, the diagnosing and initialization process of the various peripheral devices are executed. Also, the game programs and the like are written from the ROM 34 to the RAM 33 by the main CPU 32, so as to obtain the payout rate setting data and the country ID information. Also, during the execution of the initialization process, the verification process to each program is executed.

And in S2, the main CPU 32 reads out the game programs and the like from the RAM 33, and executes the programs in sequence so as to conduct the main game process. The game is executed in the slot machine 1 according to the embodiment by executing a main game process. And the main game process is repeated when the power is supplied to the slot machine 1.

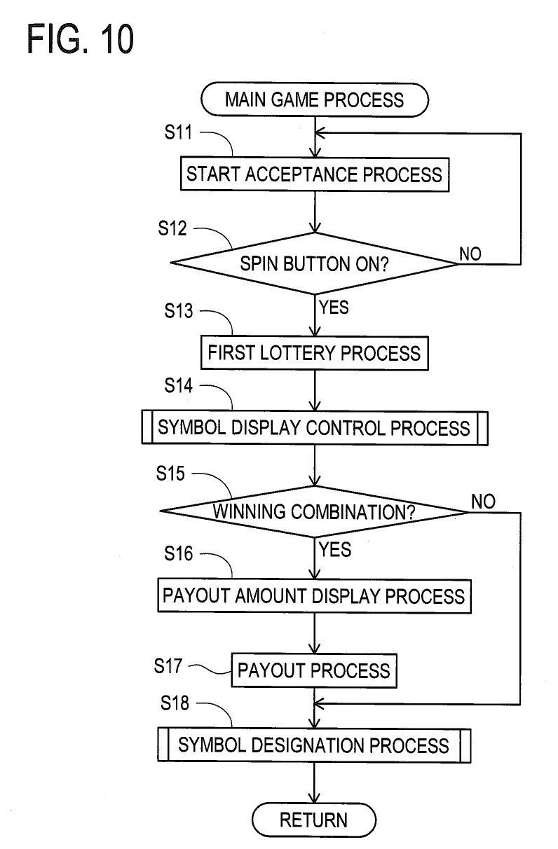

Next, the sub process of the main game process in S2 will be explained with reference to FIG. 10. FIG. 10 is a flowchart of the main game process program in the slot machine 1 according to the embodiment. Also, each program shown in the flowchart of FIG. 10 is stored in the ROM 34 or the RAM 33 of the slot machine 1, and is executed by the main CPU 32.

First, as shown in FIG. 10, a start acceptance process is executed by the main CPU 32. At this time, in the start acceptance process, the insertion of the coins or the bet operation using the BET button among the operation buttons 11 is executed by the player.

And then, it is determined by the main CPU 32 whether the spin button among the operation buttons 11 is pressed in S12. It is determined based on the input signals corresponding to the button pressing of the operation button 11 to the main CPU 32. Here, when the spin button among the operation buttons 11 is not pressed (S12: NO), the game returns to the start acceptance process again. Thereby, it is possible to change the bet number and the like. On the other hand, when the spin button among the operation buttons 11 is pressed (S12: YES), the bet number set based on the above bet operation is reduced from the credits owned by the player at that time, and is stored in the RAM 33 as bet information. And the credit count after reduction is also stored in the RAM 33 as the bet information. Then, by transmitting control signals to the sub control board 72, the main CPU 32 displays the credit information stored in the RAM 33 (the credit amounts after the deduction described above) on the credit amount display portion 9 of the liquid crystal panel 5B.

In S13, a first lottery process is executed by the main CPU 32. Concretely, when the lottery program included in the game programs is executed by the main CPU 32, the random number corresponding to each video reel respectively is selected from a range of 0 to 255. And with reference to the symbol weighting data corresponding to the payout rate setting data, based on the nine random numbers, the code number of each video reel is determined. The main CPU 32 proceeds to S14 after writing/storing the determined code number of each video reel over/in code number information in the RAM 33 so that the former corresponds to each symbol display area of the symbol display frame 111 on the liquid crystal panel 5B.

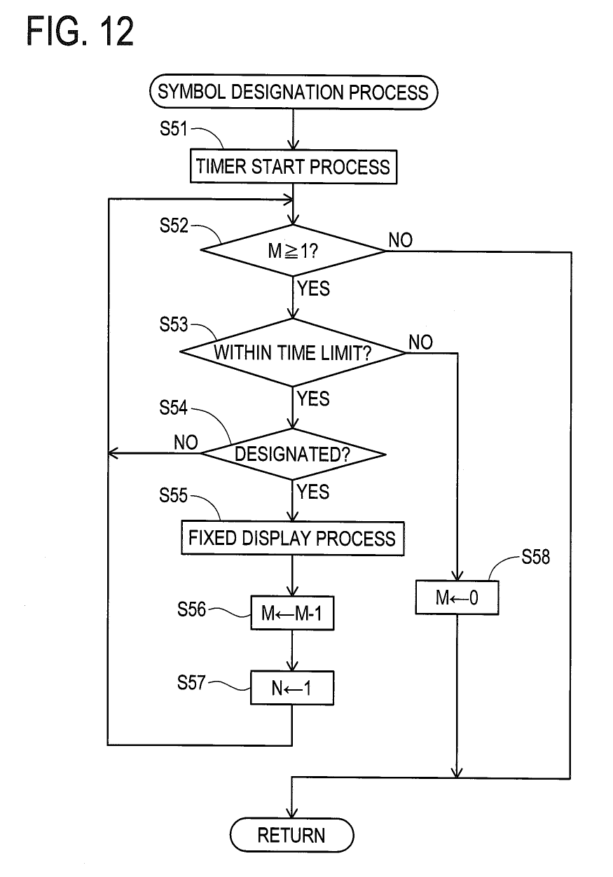

However, the symbol display areas identified by fixed information to be generated in S55 of FIG. 12 to be described later are exempt from the overwriting that is then to be executed for the first time in S13 described above, and thus the code numbers already stored are maintained.

Now, as the code number of each video reel is associated with the symbol number (symbol number in FIG. 3) to be rearranged in each symbol display area of the symbol display frame 111 on the liquid crystal panel 5B, each symbol to be rearranged in the game is determined by writing it over the code number information in the RAM 33 so that it is associated with each symbol display area of the symbol display frame 111 on the liquid crystal panel 5B. For example, if the main CPU 32 determines any of the code number of each video reel to be “21” and then writes it over the code number information in the RAM 33 so that it is associated with each symbol display area of the symbol display frame 111 on the liquid crystal panel 5B, the main CPU 32 is considered to have determined to rearrange nine [FRANKENSTEIN] symbols (refer to FIG. 3). Thus, holding a lottery of the code number of each video reel and writing it over the code number information in the RAM 33 so that it is associated with each symbol display area of the symbol display frame 111 on the liquid crystal panel 5B determines each symbol to be rearranged in a unit game of the slot game.

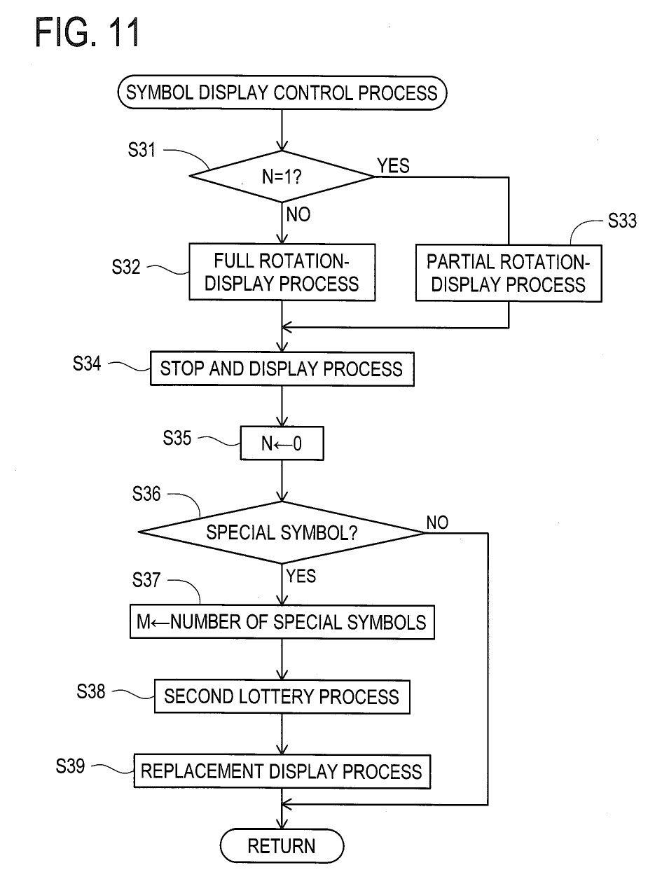

Subsequently, when proceeding to S14, the main CPU 32 executes a symbol display control process. Now, sub processes of the symbol display control process are described based on FIG. 11. FIG. 11 is a flow chart of the symbol display control process program in the slot machine 1 according to this embodiment. Additionally, respective programs shown below in the flow chart in FIG. 11 are stored in the ROM 34 or the RAM 33 of the slot machine 1, and executed by the main CPU 32.

First, as shown in FIG. 11, the main CPU 32 determines in S31 whether or not a variable N is “1”. This determination is made based on the value of the variable N stored in the RAM 33. Now, if the variable N is not “1” (S31: NO), the main CPU 32 proceeds to S32.

In S32, the main CPU 32 executes a full rotation-display process. In other words, by transmitting control signals to the sub control board 72, the CPU 32 starts rotational display of each video reel in each symbol display area of the symbol display frame 111 on the liquid crystal panel 5B. And then, the effect mode (the display mode of the images on the liquid crystal panel 5B and the sound output mode from the speakers 23) for each unit game is determined by the main CPU 32, and the sub control board 72 is ordered to start the effect in a predetermined effect pattern. And then the main CPU 32 proceeds to S34 to be described later.

Alternatively, if the variable N is “1” (S31: YES), the main CPU 32 proceeds to S33. In S33, the main CPU 32 executes a partial rotation-display process. In other words, by transmitting control signals to the sub control board 72, the main CPU 32 causes rotational display of each video reel to start in the respective symbol display areas of the symbol display frame 111 on the liquid crystal panel 5B, except for the symbol display areas identified by the fixed information to be generated in S55 of FIG. 12 to be described later. Thereafter, similar to S32 above, the effect mode (the display mode of the images on the liquid crystal panel 5B and the sound output mode from the speakers 23) for each unit game is determined by the main CPU 32, and the sub control board 72 is ordered to start the effect in a predetermined effect pattern. And then the main CPU 32 proceeds to S34 to be described later.

Subsequently, in S34, when the predetermined stop timing to display each reel in rotating manner comes, the main CPU 32 executes a reel stop process, and by transmitting control signals to the sub control board 72, stops rotating of each video reel being displayed, based on the code number written over/stored in the code number information in the RAM 33 so that it is associated with each symbol display area of the symbol display frame 111 on the liquid crystal panel 5B. This repositions each symbol determined in S13 described above in each symbol display area of the symbol display frame 111 on the liquid crystal panel 5B. However, as described above, the symbol display areas identified by the fixed information that is generated in S55 of FIG. 12 to be described later are excluded.

Subsequently, in S35, the main CPU 32 assigns “0” to a value of the variable N stored in the RAM 33. Then, the main CPU 32 proceeds to S36.

In S36, the main CPU 32 determines whether or not there is any special symbol ([ORANGE] symbol) in the symbols rearranged among the respective symbol display areas of the symbol display frame 111 on the liquid crystal panel 5B. This determination is made based on the code number written over/stored in the RAM 33. Now, if there is no special symbol ([ORANGE] symbol) (S36: NO), the main CPU 32 returns to the main game process of FIG. 10 above. Alternatively, if there is any special symbol ([ORANGE] symbol) (S36: YES), the main CPU 32 proceeds to S37.

In S37, the main CPU 32 counts the number of special symbols ([ORANGE] symbols) of the symbols rearranged in the respective symbol display areas of the symbol display frame 111 on the liquid crystal panel 5B, and assigns the count value into a value of a variable M stored in the RAM 33. This counting is performed based on the code numbers written over/stored in the RAM 33 and then the main CPU 32 proceeds to S38.

In S38, the main CPU 32 executes a second lottery process. In this second lottery process, by executing the lottery program contained in the game program, the main CPU 32 randomly selects for every special symbol a random number associated with the special symbol ([ORANGE] symbol) rearranged in the symbol display area of the symbol display frame 111 on the liquid crystal panel 5B from a range of numeric values of “0 to 255”. Then, referring to the symbol weighting data according to payout ratio setting data, and based on the selected random number, it determines code numbers (corresponding to those of the video reels) associated with the symbol display areas of the symbol display frame 111 on the liquid crystal panel 5B in which the special symbols ([ORANGE] symbols) are rearranged. However, the code numbers associated with the special symbols ([ORANGE] symbols) are excluded from the code numbers targeted for that determination. Then, after the determined code numbers are overwritten and stored in the code number information in the RAM 33 to be associated with the symbol display areas of the symbol display frame 111 on the liquid crystal panel 5B, the main CPU 32 proceeds to S39.

In S39, the main CPU 32 executes a displacement display process. In this displacement display process, by transmitting control signals to the sub control board 72, the main CPU 32 replaces the special symbol ([ORANGE] symbol) with the scatter symbol (any of each symbol of [FRANKENSTEIN], [BLUE7], [BELL], [APPLE], [CHERRY], [STRAWBERRY], [PLUM]) associated with the code number determined in S38 described above and displays it, for the symbol display areas of the symbol display frame 111 on the liquid crystal panel 5B in which the special symbol ([ORANGE] symbol) is rearranged. Then, rotational display/stop display of the video reels does not take place. Thereafter, the main CPU 32 returns to the main game process of FIG. 10 above.

Subsequently, returning to the main game process of FIG. 10 above, the main CPU 32 proceeds to S15 where it determines whether or not there is any winning combination. This determination is made based on the code numbers written over/stored in the code number information in RAM 33 so that they are associated with the respective symbol display areas of the symbol display frame 111 on the liquid crystal panel 5B. Now, if there is no winning combination (S15: NO), the main CPU 32 proceeds to S18 to be described later. Alternatively, it proceeds to S16 if there is any winning combination (S15: YES).

In S16, a payout amount display process is executed by the main CPU 32. Concretely, first, the payout amount obtained by multiplying the payout amount corresponding to the winning combination (the number of same scatter symbol) rearranged in the symbol display frame 111 of the liquid crystal panel 5B with the bet number is calculated. And the calculation is executed based on the bet information in the RAM 33 and the payout table of FIG. 6, and the calculated amount is stored in RAM 33 as payout information. And then, the control signals are transmitted to the display portion driving circuit 67 by the main CPU 32, the payout information stored in the RAM 33 (the above calculated amount) is displayed on the payout amount display portion 8 of the liquid crystal panel 5B.

Next, in S17, a payout process is executed. In the payout process, the payout amount awarded to the player in the slot game, is paid out to the player, based on the payout information stored in the RAM 33.

When the payout is executed, the credits which are stored in the RAM 33 as the payout information (the payout amount awarded to the player in the slot game) are added to the credits stored in the RAM 33 as credit information, and the added value is overwritten in the RAM 33 as the credit information. And then, the control signals are transmitted to the display portion driving circuit 67 by the main CPU 32, the credits information stored in the RAM 33 (the added value in S17) is displayed on the credit amount display portion 9 of the liquid crystal panel 5B. At the same time, “0” is overwritten to the RAM 33 as the payout information, and by transmitting the control signals to the display portion driving circuit 67, on the payout amount display portion 8 of the liquid crystal panel 5B, “0” is displayed.

In the payout process, the credits awarded to the player at that time (1 credit equals to 1 coin) may be paid out by the coins corresponding to based on the pressing on the CASHOUT button among the operation buttons 11, or may also be paid out by a ticket with a bar code which is printed by the ticket printer 14.

And the main game process is executed again after the payout process in above S17 is executed by the main CPU 32 via a symbol designation process described below.

In the following, sub processes of the symbol designation process of S18 above are described based on FIG. 12. FIG. 12 is a flow chart of the symbol designation process program in the slot machine 1 according to this embodiment. Additionally, respective programs shown below in the flowchart in FIG. 12 are stored in the ROM 34 or the RAM 33 of the slot machine 1, and executed by the main CPU 32.

First, as shown in FIG. 12, the main CPU 32 executes a timer start process in S51. In this timer start process, the main CPU 32 starts to activate the timer 109. Then, the main CPU 32 proceeds to S52.

In S52, the main CPU 32 determines whether or not the variable M is “1” or greater. This determination is made based on a value of the variable M stored in the RAM 33. Now, if the variable M is less than “1” (S52:NO), the main CPU 32 returns to the main game process of FIG. 10 above. Alternatively, if the variable M is “1” or greater (S52: YES), the main CPU 32 proceeds to S53.

In S53, the main CPU 32 determines whether or not it is within time limit. This determination is made based on an input signal from the timer 109. Now, if it is within time limit (S53: YES), the main CPU 32 proceeds to S54.

In S54, the main CPU 32 determines whether or not the player has designated any of the scatter symbols rearranged in the respective symbol display areas of the symbol display frame 111 on the liquid crystal panel 5B. This determination is made based on an input signal from the touch panel 101. Now, if it is determined that the player has not designated (S54: NO), the main CPU 32 returns to S52 above and repeats the processes after S52 above. Alternatively, if it is determined that the player has designated (S54: YES), the main CPU 32 proceeds to S55.

In S55, the main CPU 32 executes a fixed display process. In this fixed display process, the main CPU 32 identifies the symbol display area in which the scatter symbol designated by the player in S54 described above within the respective symbol display areas of the symbol display frame 111 on the liquid crystal panel 5B is rearranged as a symbol display area in which fixed display of the scatter symbol is to be executed, and stores accordingly in the fixed information in the RAM 33. Then, the main CPU 32 proceeds to S56.

In S56, the main CPU 32 decrements the variable M by “1”. Then, the main CPU 32 proceeds to S57. In S57, the main CPU 32 assigns “1” into the variable N. Then, returning to S52 described above, it repeats processes in and after S52 described above. However, when the determination of S54 above is executed again, the scatter symbols that have been already targeted in a same loop are excluded from the target for determination.

Further, if it is not within time limit, (S53: NO), the main CPU 32 proceeds to S58 where it assigns “0” into the variable M, and then returns to the main game process of FIG. 10 above. Further, it terminates activation of the timer 109 in S58 described above.

As described above in detail, in each unit game of the slot game executed in the slot machine 1 according to this embodiment, as shown on the right side liquid crystal panel 5B in the first stage in FIG. 1, the special symbols ([ORANGE] symbols) may be rearranged in the symbol display frame 111 (S36: YES). In this case, the special symbols ([ORANGE] symbol) are automatically replaced with any of the scatter symbols (respective symbols of [FRANKENSTEIN], [BLUE7], [BELL], [APPLE], [CHERRY], [STRAWBERRY], and [PLUM]) (S39).

Subsequently, by touching and inputting on the touch panel 101, the player can designate any of the scatter symbols rearranged in the symbol display area 111 of the liquid crystal panel 5B (S54: YES), with limits of the number of the special symbols ([ORANGE] symbols) (S37, S52: YES, S56, S58) that were replaced with any scatter symbols. Further, when the player presses the operation button 11 of the spin button (S12: YES) after pressing the operation button 11 of the BET button and setting the bet number, and starts a next unit game, as in the liquid crystal panel 5B shown on the left side in the third stage in FIG. 1, the scatter symbols designated by the player are fixedly displayed in the symbol display frame 111, while in symbol display areas other than the symbol display areas in which the scatter symbols are fixedly displayed, each video reel rotates and a symbol sequence drawn on the reel band of each video reel as shown in FIG. 3 is scroll displayed from top to down (S33).

Subsequently, when a predetermined period of time has elapsed, each video reel being rotated automatically stops, one symbol drawn on the reel band of each video reel as shown in FIG. 3 is displayed in a stopped manner in any symbol display area other than the symbol display areas in which scatter symbols are fixedly displayed (S34). Even then, if the special symbol ([ORANGE] symbol) is rearranged in the symbol display frame 111 (S36: YES), the special symbol ([ORANGE] symbol) is automatically replaced with any of the scatter symbols ([FRANKENSTEIN], [BLUE7], [BELL], [APPLE], [CHERRY], [STRAWBERRY], [PLUM]) (S39).

Subsequently, a payout amount according to the number of same scatter symbols rearranged in the symbol display frame 111 of the liquid crystal panel 5B is displayed on the payout amount display portion 8 (S16) and is awarded to the player (S17).

Thus, if the player designates any of the scatter symbols rearranged in the symbol display area 111 of the liquid crystal panel 5B, by touching and inputting on the touch panel 101 (S54: YES), the scatter symbols designated by the player are fixedly displayed in a next unit game, as in the symbol display frame 111 of the liquid crystal panel 5B shown on the left side in the third stage in FIG. 1 (S33). Thus, a player can seek any payment the player intends that is based on scatter symbols in a next unit game.

Further, assume that in each unit game of the slot game executed at the slot machine 1 according to this embodiment, as shown in the symbol display frame 111 of the liquid panel 5B on the right side in the first stage in FIG. 1, any special symbols ([ORANGE] symbols) that are not connected with any payment are rearranged (S36: YES). In this case, the special symbols ([ORANGE] symbols) are automatically replaced with any of the scatter symbols (each symbol of [FRANKENSTEIN], [BLUE7], [BELL], [APPLE], [CHERRY], [STRAWBERRY], and [PLUM]) (S39). This enables to ensure expectation about payment based on scatter symbols in a next unit game and fairness in a specified range of the scatter symbols.

Further, when the player designates the scatter symbol rearranged in the symbol display frame 111 of the liquid crystal panel 5B (S54: YES), tactics is added when scatter symbols are designated because the number of special symbols ([ORANGE] symbols) replaced with any scatter symbol is considered the limits of the designated number (S37, S52: YES, S56, S58).

Additionally, the present invention is not limited to the embodiments described above, but various changes may be made without departing from its scope.

For example, if the special symbol ([ORANGE] symbol) is rearranged in the symbol display frame 111 of the liquid crystal panel 5B, the payout amount display process of S16 described above and the payout process of S17 described above may also be executed before the special symbol ([ORANGE] symbol) is automatically replaced with any of the scatter symbols.

What is claimed is:

1. A slot machine comprising:
a display which displays a plurality of symbols, the plurality of symbols randomly displayed among a plurality of scatter symbols, number of which is a basis of awarding a prize to a player, and a special symbol;
a touch panel through which the player designates any of the plurality of symbols displayed on the display; and
a processor controlling the display and the touch panel, programmed to execute processes of:
(a) rearranging the plurality of symbols displayed on the display;
(b) if the special symbol is displayed on the display as a result of the rearranging, allowing the player to designate any of the plurality of scatter symbols displayed on the display through the touch panel; and
(c) if one of the plurality of scatter symbols is designated by the player, fixedly displaying the scatter symbol designated, and rearranging the plurality of symbols except the scatter symbol designated.

2. The slot machine of claim 1, wherein the processor replaces, when the special symbol is displayed at the process (b), the special symbol which is displayed with one of the plurality of scatter symbols.

3. The slot machine of claim 1, wherein the processor limits the number of scatter symbols which the player is allowed to designate through the touch panel at the process (b) within the number of special symbols displayed on the display.

4. A slot machine comprising:
a display which displays a plurality of symbols, the plurality of symbols randomly displayed among a plurality of scatter symbols, number of which is a basis of awarding a prize to a player, and a special symbol;
a touch panel through which the player designates any of the plurality of symbols displayed on the display; and
a processor controlling the display and the touch panel, programmed to execute processes of:
(a) rearranging the plurality of symbols displayed on the display;
(b-1) if the special symbol is displayed on the display as a result of the rearranging, allowing the player to designate any of the plurality of scatter symbols displayed on the display through the touch panel;
(b-2) if the special symbol is displayed on the display, replacing the special symbol which is displayed with one of the plurality of scatter symbols;
(b-3) limiting the number of scatter symbols which the player is allowed to designate through the touch panel within the number of special symbols displayed on the display; and
(c) if one of the plurality of scatter symbols is designated by the player, fixedly displaying the scatter symbol designated, and rearranging the plurality of symbols except the scatter symbol designated.
